(19) United States
(12) Patent Application Publication
(10) Pub. No.: US 2023/0311178 A1
(43) Pub. Date: Oct. 5, 2023

(54) LARGE-SCALE DRY, COMPRESSED, AND WRAPPED BIOMASS BURIAL AND ANAEROBIC ENTOMBMENT

(71) Applicant: EXXONMOBIL TECHNOLOGY AND ENGINEERING COMPANY, Annandale, NJ (US)

(72) Inventors: Zarath M Summers, High Bridge, NJ (US); Harry W. Deckman, Clinton, NJ (US)

(21) Appl. No.: 18/194,340

(22) Filed: Mar. 31, 2023

Related U.S. Application Data
(60) Provisional application No. 63/327,050, filed on Apr. 4, 2022.

(51) Int. Cl. B09B 3/32; B09B 1/00; B09B 3/40

(52) U.S. Cl. CPC B09B 3/32; B09B 1/00; B09B 3/40

(57) ABSTRACT

A variety of methods are disclosed, including, in one embodiment, a method including: providing a biomass source; processing the biomass source to remove water from the biomass source; compacting the biomass source to increase density of the biomass source to produce biomass briquettes; wrapping the biomass briquettes with a plastic membrane; and placing the biomass briquettes in an engineered landfill.

### CROSS REFERENCE TO RELATED APPLICATIONS

This non-provisional patent application claims priority to U.S. provisional patent app. No. 63/327,050, filed Apr. 4, 2022, and titled “Large-Scale Dry, Compressed, and Wrapped Biomass Burial and Anaerobic Entombment,” the entire contents of which is incorporated herein by reference.

### FIELD

This application relates to biological carbon capture and anaerobic sequestration of carbon.

### BACKGROUND

Climate science scenarios limiting global temperature rise to less than 2 degrees by the end of the century employ a mixture of deep decarbonization, carbon capture and sequestration (CCS) from point sources, and carbon negative options. The cost of CO₂ capture and geologic sequestration from point sources has been estimated to be in a range from ˜$40-$140/metric ton (2013 dollars). For climate pathways that limit temperature rise, the cost of CO₂ becomes significantly larger later in this century. Although it is not known how the technology mix will evolve or what price structure will emerge, it is well recognized that a cost effective and scalable negative emission technology would significantly impact this evolution. The present technologies for carbon capture and sequestration will likely not be able to meet the demand for carbon sequestration. Further, the presently utilized technologies are costly per ton of sequestered CO₂.

### SUMMARY

Disclosed herein is a method comprising: providing a biomass source; processing the biomass source to remove water from the biomass source; compacting the biomass source to increase density of the biomass source to produce biomass briquettes; wrapping the biomass briquettes with a water repellent membrane; and placing the biomass briquettes in a landfill.

Further disclosed herein is an engineered landfill comprising: a base comprising at least a clay; a water repellent geomembrane; biomass briquettes wrapped with a water repellent membrane; and a cap; wherein the water repellent geomembrane is disposed between the base and the cap, and wherein the biomass briquettes are disposed between the base and the cap within the water repellent geomembrane.

Further disclosed herein is a method comprising: providing a biomass source comprising lignocellulose in an amount greater than 40 wt. %; drying the biomass source such that the biomass source has a water activity of 0.6 or less; compacting the biomass source to have a density of about 0.7-1.4 g/cm³ to produce biomass briquettes; wrapping the biomass briquettes with a water repellent membrane; and placing the biomass briquettes in an engineered landfill.

These and other features and attributes of the disclosed methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is an illustrative depiction of an embodiment of a biological carbon capture and sequestration process in accordance with certain embodiments of the present disclosure.

FIG. 2 is an illustrative depiction of an embodiment of a biomass briquette in accordance with certain embodiments of the present disclosure.

FIG. 3 is a chart of cost structure for dehydrated miscanthus, switchgrass, and pine for of a biological carbon capture and sequestration process in accordance with certain embodiments of the present disclosure.

FIG. 4 is a chart of cost structure for chemically processed miscanthus, switchgrass, and pine for of a biological carbon capture and sequestration process in accordance with certain embodiments of the present disclosure.

FIG. 5 is a chart of cost structure for a dried biomass carbon sequestration process with fuel production in accordance with certain embodiments of the present disclosure.

### DETAILED DESCRIPTION

Disclosed herein are carbon capture and sequestration methods and more particularly, methods and systems of direct air carbon capture through biological carbon capture followed by anaerobic carbon capture and sequestration. Biological carbon capture and anaerobic sequestration, sometimes referred to herein as BIO-CCS, is a direct air carbon capture concept that has the potential to offset a significant fraction of the world's CO₂ emissions at a cost that is lower than other carbon capture technologies. One particular advantage of the presently disclosed methods is the stable, long-term anaerobic sequestration of biogenic carbon within engineered landfills with reduced biogas emissions. The methods described herein utilize technologies that mitigate or control anaerobic degradation processes that would otherwise result in production of biogas such as methane and CO₂.

The methods disclosed herein generally include selection of a biomass, processing the biomass, and placing the processed biomass in a landfill. The methods disclosed utilize significant modifications and enhancements to traditional municipal landfill practices. Scalability of the methods is achieved by the size and efficiency of the agricultural industry, and the relatively small amount of land needed for anaerobic sequestration.

In the BIO-CCS process, anaerobic sequestration of biogenic carbon is achieved by placing the biogenic carbon in an engineered landfill where processing and handling of the biogenic carbon prior to placement in the engineered landfill work to avoid or mitigate decomposition of the biogenic carbon into biogases such as CO₂ and CH₄. One advantage of the present methods is that biogas formation is delayed by hundreds to thousands of years with fugitive emissions of these greenhouse gases controlled and captured easily. In embodiments, the biogenic carbon is derived from harvested biomass and/or from a biogenic carbon waste product from chemical conversion of biomass.

In embodiments, biogenic carbon undergoes chemical conversion processes to convert a portion of the biogenic carbon into a fuel or chemical product and a portion of the biogenic carbon remains as a biogenic carbon waste product. In further embodiments, biogenic carbon undergoes chemical conversion which removes water and volatile components from the biogenic carbon to produce the biogenic carbon waste product without converting the biogenic carbon to fuels or chemical products. Some examples of chemical conversion processes include, without limitation, torrefaction, carbonization, anaerobic digestion, and liquid biofuel production. Bio-CCS methods which include chemical processing of the biogenic carbon that preserve a majority of the carbon in the biogenic carbon, i.e., those chemical processes which do not produce fuels and chemical products are referred to herein as Agro-CSS. In embodiments, the biogenic carbon, either as harvested biomass or biogenic carbon waste product, is further processed before placement into the engineered landfill. Some processing methods for harvested biomass or biogenic carbon waste product include dehydration, briquetting, and the use of water repellent membranes to reduce water contact with the briquettes once placed in a landfill.

In embodiments, Bio-CCS methods utilize lignocellulose containing plants as the biogenic carbon. As will be discussed in further detail below, in anaerobic conditions in engineered landfills, biogenic carbon derived from lignocellulose containing plants minimally degrades thereby providing long term sequestration of the biogenic carbon. Further, biogenic carbon derived from lignocellulose containing plants employs agriculture and forestry for an efficient and scalable form of atmospheric carbon capture to yield net-negative carbon emissions. Additional sources of biogenic carbon include municipal and/or agricultural biomass. Table 1 shows examples of suitable high productivity lignocellulose containing plants for BIO-CCS.

TABLE 1

| Classification | Technical Name | Common Name |
|---|---|---|
| Herbaceous Grass | Miscanthus | Miscanthus × giganteus, Silvergrass |
| Herbaceous Grass | Panicum Virgatum | Switchgrass |
| Herbaceous Grass | Pennisetum | Elephant Grass, Napier Grass, Uganda |
| | purpureum | Grass |
| Herbaceous Grass | Arduno donax | Giant Reed, Indian Grass, Spanish Reed |
| Hybrid | Miscanthus × | Makarikari Grass |
| | Sugarcane | |
| Nitrogen Fixing | Pueraria | Kudzu, Japanese Arrowroot |
| Nitrogen Fixing | Medicago sativa | Alfalfa |
| Woody | Bambusoideae | Bamboo |
| Short Rotation | Salix | Common Osier, Basket Willow, Willow |
| Coppice | | |
| Short Rotation | Populus | Poplar, Hybrid poplar, Eastern |
| Coppice | | Cottonwood |
| Short Rotation | Eucalyptae | Eucalyptus, Gum Tree |
| Coppice | | |
| Hybrid Tree | Transgenic Trees | Transgenic Eucalyptus |
| Tree/Shrub | Acacia | Mimosa, Avacia, Thorntree, Wattle |
| Tree | Pinus | Pine, Loblolly Pine |
| Aquatic | Seaweed | Kelp |
| Herbaceous Plant | Agave tequilana | Blue agave, Tequila agave |
| Herbaceous Plant | Saccharum | Energy Cane, Sugarcane |

In the BIO-CSS process, maximizing lignin content of the biomass increases the carbon mass fraction as well as the degradation resistance of the sequestered biomass. To meet economic constraints and to maximize degradation resistance, high productivity plants and trees such as those in Table 1, sometimes referred to as energy crops, are selected for the BIO-CSS process. In embodiments, high productivity plants and trees include those with dry biomass yields in a range from 1.75 to 17.5 metric tons per acre or greater. The wide range of suitable crops for biomass harvesting shown in Table 1 can be grown in diverse locations and climates throughout the world which allows the Bio-CCS process to be applied in diverse locations. In addition, many of the crops in Table 1 can be grown on marginal or degraded lands with reduced yields. The weight fraction of carbon in the dry biomass of plants listed in Table 1 ranges from 40 wt. % to 55 wt. % giving an offset for the different conversion and sequestration scenarios disclosed herein of 1.3 to 1.8 metric ton CO₂ equivalent per metric ton dry biomass.

To be effective, long-term carbon sequestration should be stable for periods of greater than a few hundred years, and preferably, thousands to tens-of-thousands of years. Establishing the efficacy of sequestration for thousands to tens-of-thousands of years will require a significant amount of biological, civil engineering, and geological research as well as numerous long term demonstration projects. A nearer-term goal is the establishment of a technology that sequesters carbon for hundreds of years and manages fugitive emissions such as in the disclosed BIO-CSS process. Long-term sequestration of biogenic carbon requires preventing or mitigating anaerobic decomposition and degradation of the biomass that ultimately produces biogases such as CO₂ and methane.

In anaerobic environments, methane is formed primarily through fermentation fed methanogenesis of biomass. In aerobic environments, biomass degrades primarily through microbial aerobic respiration creating a gaseous effluent that is predominantly CO₂. Formation of biogas in anaerobic environments is mediated by complex communities of micro-organisms that participate in either a three or four step cooperative decomposition pathway, which will be briefly described to provide context for options that can mitigate degradation. In embodiments, there is a primary phase of aerobic decomposition in which enzymatic hydrolysis produces smaller organic compounds including glucose, xylose, fatty acids, and amino acids. These simpler, soluble compounds serve as substrates for aerobic microbial metabolism that release chemical energy as oxidation proceeds. Once oxygen is depleted, anaerobic fermentative and acetogenic bacteria convert water soluble compounds formed in the hydrolysis phase into a variety of organic acids and alcohols as well as releasing CO₂ and H₂. In some embodiments, anaerobic fermentation occurs without the first step of aerobic decomposition. In embodiments, a second phase in which acidity increases is referred to as acidogenesis and acetic acid is a primary product that is used in subsequent stages of degradation. Oxidation of volatile fatty acids formed during acidogenesis to products such as acetate, CO₂, and H₂ is then accomplished in the next phase by acetogenic bacteria. Metabolism of acetogenic bacteria is inhibited by products they produce such as H₂ and acetate. A symbiotic relationship exists with methanogenic organisms that in the final phase consume H₂, CO₂, and/or acetate to produce methane. Methanogens are anaerobic Archaea that grow either autotrophically using CO₂ as a carbon source and as an electron acceptor with hydrogen as an electron source, or acetoclastic and methylotrophic methanogens that grow heterotrophically using organic substrates as an energy source producing methane in the final step of the pathway.

There is a limit on conversion of biomass to biogas because most steps in the anaerobic portion of the pathway will shut down once oxygen supplied by the molecular composition of the biomass is consumed. As such, one method to limit conversion of biomass to biogas is to remove the oxygen present in the biomass prior to placement in an engineered landfill. Another approach to sequestered biomass preservation is to limit aerobic decomposition before burial thus mitigating the first step in the decomposition pathway. In all cases this is a best practice, and mechanisms for achieving this include: limiting decomposition of the biomass while it is stored before burial, limiting the amount of aerobic voidage in the landfill, and preventing the invasion of groundwater carrying dissolved oxygen into the landfill. A different, more general approach to preventing decomposition is to limit water activity (relative humidity) within the landfill. All of the biological steps in the biogas generation pathway require water for microorganisms to survive. Reducing water activity (a_{w}) below 0.6 reduces or eliminates most organisms responsible for biogas formation. Thus, limiting water activity to 0.6 or below controls the growth of organisms and controls the formation of biogas.

An additional feature incorporated into the Bio-CCS processes disclosed herein is a provision to monitor as well as collect any biogas generated in the landfill. In a successful sequestration scenario no biogas would be generated, however, in the event that anaerobic degradation occurs, the monitoring and collection system would be used to prevent methane from being emitted to the atmosphere. Similar monitoring and collection systems are currently used as best practices in municipal landfills.

As discussed above, the biogenic carbon, either as harvested biomass or biogenic carbon waste product, undergoes a chemical conversion process including torrefaction, carbonization, anaerobic digestion, and liquid biofuel production before placement into the engineered landfill.

Torrefaction is a process of anaerobic pyrolysis whereby biomass is heated under anaerobic conditions to introduce a limited amount of carbonization to facilely degrade components of the biomass to biogas and to drive off moisture content. Torrefaction reduces the carbon content of the biomass by 10%-20% and removes a majority of the oxygen from the biomass. When lignocellulose containing biomass undergoes torrefaction, the product of the torrefaction is similar to low rank coals (lignite) which are resistant to anaerobic biodegradation. Torrefaction is carried out at any suitable temperature, such as from 200° C. to 350° C. in oxygen-free atmosphere. Alternatively, from 200° C. to 250° C., 250° C. to 300° C., 300° C. to 350° C., or any ranges therebetween. Residence times are selected based on torrefaction equipment configurations. Suitable residence times include less than 5 hours, less than 3 hours, or less than 2 hours.

Carbonization is a more aggressive anaerobic pyrolysis process that converts ˜50% of the carbon in lignocellulosic biomass into an oxygen depleted char. Depleted char is expected to be even more degradation resistant than torrefaction products and can be used as a coal substitute as well as a soil amendment in aerobic environments. Carbonization is carried out at any suitable temperature, such as from 350° C. to 700° C. in oxygen-free atmosphere. Alternatively, from 350° C. to 450° C., 450° C. to 550° C., 550° C. to 650° C., 650° C. to 700° C., or any ranges therebetween. Residence times are selected based on carbonization equipment configurations. Suitable residence times include greater than 5 hours to 5 days. Alternatively, from 5 hours to 1 day, 1 day to 2 days, 2 days to 3 days, 3 days to 4 days, 4 days to 5 days, or any ranges therebetween.

Anaerobic digestion is a process whereby the biomass is digested in a reactor to produce biogas and anaerobic digestate. Reactor conditions are selected such that the anaerobic digestion leaves a majority of the lignin content of the biomass unaltered in the digestate. Fibrous plants and trees with lignin content of 40%-60% of the total biomass carbon are good candidates to be anaerobically processed to form anaerobic digestate. Suitable conditions include from 35° C. to 70° C. in oxygen-free atmosphere. Alternatively, from 35° C. to 45° C., 45° C. to 55° C., 55° C. to 65° C., 65° C. to 75° C., or any ranges therebetween.

Another chemical conversion process includes converting lignocellulosic biomass to liquid fuels and a solid byproduct. The disclosed Bio-CCS can be used as a bolt-on technology to a second-generation liquid biofuel plant. Second-generation liquid biofuel production splits lignocellulose into constituent lignin and cellulose whereby the cellulose is converted to alcohols.

Once the biomass has been processed as above, the biomass is placed into engineered landfills. Engineered landfills for Bio-CCS would be widely distributed, located within 5 to 100 miles of agricultural or forestry sites, and would be sized to process biomass in a range from 10 to 5,000 KiloTonne/Year. Further, the chemical conversion processes such as drying, torrefaction, carbonization, anaerobic digestion, or production of liquid biofuels could be co-located with the engineered landfills. The simplest and least expensive biomass processing is drying. Variations of drying technologies are considered to be part of any Bio-CCS scenario for harvested biomass or chemically converted biomass. In principle dried biomass could be placed and mechanically compacted in the engineered landfill, however there will be challenges in keeping the biomass dry and the density of the biomass after compaction is likely to be less than 0.3 g/cc.

To increase the density and improve the probability of dry sequestration, after chemical conversion and/or drying, the biomass is compressed into briquettes that are bundled and then wrapped with a water repellent membrane that acts as a water vapor barrier. Any suitable water repellent membrane may be used which slows ingress of water to the briquettes. Water repellent membranes may include, without limitation virgin materials, recycled materials, and waste materials. Some specific examples of water repellent membranes may include, without limitation, polymeric membranes such as plastic membranes including polyethylene, polypropylene, polyvinyl chloride, polyethylene terephthalate, acrylonitrile-butadiene-styrene, rubber membranes such as natural rubber, neoprene rubber, silicone rubber, nitrile rubber, EPDM rubber, styrene-butadiene rubber, butyl rubber, fluorosilicone rubber, and lignocellulosic membranes such as paper, and wax coated paper, for example. In embodiments, the water repellent membrane may be sourced from recycled plastics such as ocean plastic and municipal recycled plastics, recycled rubber, recycled lignocellulosic materials or other plastic waste materials. As the water repellent membrane is being entombed underground, color, odor, and antioxidant (UV, O2) content are not of consequence, allowing for polymers with lower performance than in other commercial applications. In embodiments, the water repellent membrane has any suitable thickness, including from 0.1 mil to 10 mil, for example. Briquetting with a water repellent membrane limits mass transfer of water both helping with desiccation and providing a highly densified fill (0.7-1.4 g/cc) that efficiently uses space in the bio-landfill.

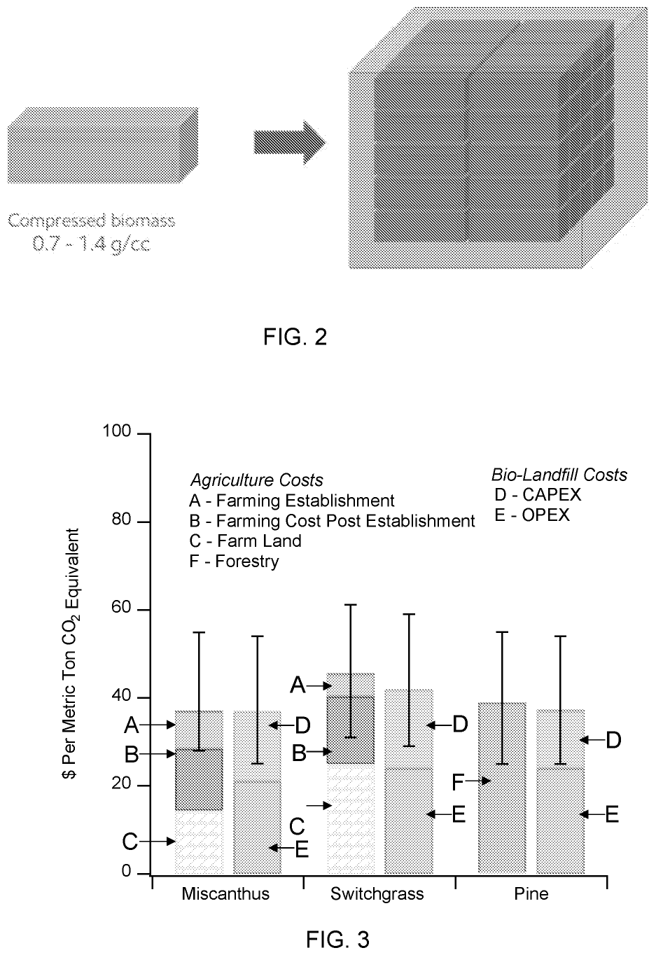

FIG. 2 is an illustrative depiction of an embodiment of a biomass briquette and briquette bundle in accordance with certain embodiments of the present disclosure. With high fill densities, bio-landfill designs can store 15,000-75,000 metric tons of biomass per acre and bio-landfills for Agro-CCS scenarios, on a yearly basis, require 0.005%-0.075% of the land area used for agriculture or forestry. Table 2 shows illustrative land use and sequestered biomass for different packing densities.

TABLE 2

| Sequestered CO₂ | Biomass Packing | Required | Required |
|---|---|---|---|
| (In biomass) | Density (ton/acre) | Landfill Acres | Square Miles |
| 1 Gt | 15,000 | 66 k | 100 |
| 1 Gt | 75,000 | 13 k | 20 |
| 45 Gt | 15,000 | 3M | 4700 |
| 45 Gt | 75,000 | 0.6M | 940 |

For long term preservation of dryness, bio-landfill designs are based on best practices for municipal landfills with some notable enhancements intended to reduce groundwater invasion to a level deemed acceptable for Bio-CCS. Better municipal landfill designs have low permeability base and cap structure which can include geocomposites, clay or geosynthetic clay layers, phytocapping, as well as gas and liquid management features. The engineered landfills for BIO-CSS include these features as well additional designs which further reduce communication with groundwater by adding at least one additional low permeability layer such as a water repellent membrane layer as described above to both the cap and base structures. This water repellent membrane layer is added to mitigate defects in and would be separated from the existing geomembrane by a layer of clay or geosynthetic clay. This design is expected to limit yearly maximum water invasion to an amount equivalent to less than the mass of a 20 micron thick layer coating the interior geomembrane surface. When briquette bundles are stacked into the engineered landfill they have to be placed in a manner that protects them from accumulations of rain, snow, or ice. An operational protocol envisioned in which briquette bundles are loaded into the landfill and the briquette bundles are covered with a temporary tarp system that is anchored to earthen causeways that form channels such that water can flow away from the briquette bundles. Optionally, additional fill is placed in the channels. Envisaged construction would first excavate a portion of the landfill to depth, install geomembranes in that section along with a base drainage and gas collection system, and then begin building earthen causeways forming the channels with dry, rock-free soil. Landfill excavation is meant to leave a small slope to drain water away from the end being filled. The landfill causeways are gradually built up in approximately meter thick steps after channels are filled to capacity.

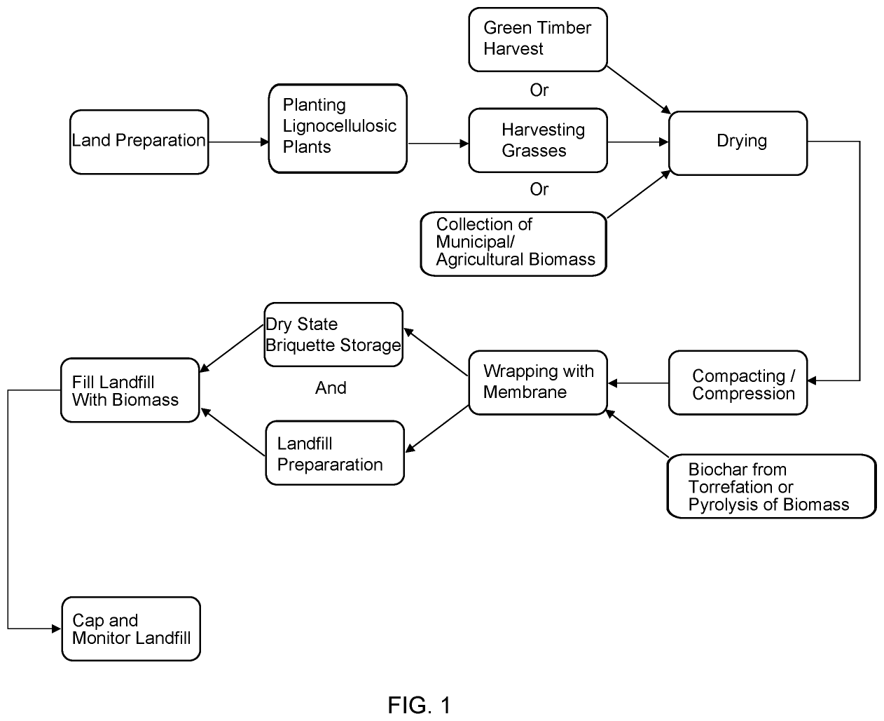

FIG. 1 is an illustrative depiction of an embodiment of a biological carbon capture and sequestration process. As shown in FIG. 1, the biological carbon capture and sequestration process begins with land preparation for planting lignocellulose containing plants. After land preparation, lignocellulosic plants are planted on the prepared land. Examples of suitable lignocellulosic plants are discussed above and may include green timber, grasses, and agricultural or municipal biomass, for example. After planting, the lignocellulosic plants are harvested and dried as biomass. The biomass is compacted and/or compressed before wrapping with a plastic membrane. Biochar from torrefaction or pyrolysis of biomass, anaerobic digestate, and solids from biofuel production are also included in the plastic membrane wrapping. In the next step. The wrapped briquettes are stored in a dry state and the landfill is prepared. The wrapped briquettes are placed in the engineered landfill. After the landfill is full, the engineered landfill is capped and monitored.

### Additional Embodiments

Accordingly, the present disclosure may provide methods of sequestering carbon with long term storage. The methods/systems/compositions/tools may include any of the various features disclosed herein, including one or more of the following statements.

Embodiment 1. A method comprising: providing a biomass source; processing the biomass source to remove water from the biomass source; compacting the biomass source to increase density of the biomass source to produce biomass briquettes; wrapping the biomass briquettes with a water repellent membrane; and placing the biomass briquettes into a landfill.

Embodiment 2. The method of embodiment 1 wherein the biomass source comprises lignocellulosic biomass.

Embodiment 3. The method of any of embodiments 1-2 wherein the biomass source comprises anaerobic digestate.

Embodiment 4. The method of any of embodiments 1-3 wherein the biomass source comprises torrefied biomass.

Embodiment 5. The method of any of embodiments 1-4 wherein the biomass source comprises carbonized biomass.

Embodiment 6. The method of any of embodiments 1-5 wherein the biomass briquettes have a density of about 0.7-1.4 g/cm³.

Embodiment 7. The method of any of embodiments 1-6 wherein the biomass briquettes have a water activity of 0.6 or less.

Embodiment 8. The method of any of embodiments 1-7 wherein the biomass briquettes comprise water in an amount of less than 4 wt. %.

Embodiment 9. The method of any of embodiments 1-8 wherein the water repellent membrane comprises at least one membrane selected from the group consisting of polymeric membranes, rubber membranes, lignocellulosic membranes, and combinations thereof.

Embodiment 10. The method of any of embodiments 1-9 wherein the water repellent membrane comprises at least one membrane selected from the group consisting of polyethylene, polypropylene, polyvinyl chloride, polyethylene terephthalate, acrylonitrile-butadiene-styrene, natural rubber, neoprene rubber, silicone rubber, nitrile rubber, EPDM rubber, styrene-butadiene rubber, butyl rubber, fluorosilicone rubber, paper, wax coated paper, and combinations thereof.

Embodiment 11. The method of any of embodiments 1-10 wherein the water repellent membrane comprises recycled materials and/or waste materials.

Embodiment 12. The method of embodiment 9 wherein the water repellent membrane comprises a membrane thickness of 0.1 mil to 10 mil.

Embodiment 13. The method of any of embodiments 1-12 wherein the comprises a low permeability base and a water repellent geomembrane placed between the biomass briquettes and the low permeability base.

Embodiment 14. The method of embodiment 12 wherein the low permeability base comprises at least one base material selected from the group consisting of clay, geosynthetic clay, and combinations thereof.

Embodiment 15. The method of embodiment 12 wherein the landfill further comprises a cap and wherein the water repellent geomembrane is further placed between the cap and the biomass briquettes.

Embodiment 16. The method of any of embodiments 1-15 wherein the landfill comprises an engineered landfill.

Embodiment 17. The method of any of embodiments 1-16 further comprising bundling the biomass briquettes to form briquette bundles and placing the briquette bundles into the landfill.

Embodiment 18. An engineered landfill comprising: a base comprising at least a clay; a water repellent geomembrane; biomass briquettes wrapped with a water repellent membrane; and a cap; wherein the water repellent geomembrane is disposed between the base and the cap, and wherein the biomass briquettes are disposed between the base and the cap within the water repellent geomembrane.

Embodiment 19. The engineered landfill of embodiment 18 wherein the biomass briquettes comprise lignocellulosic biomass.

Embodiment 20. The engineered landfill of any of embodiments 18-19 wherein the biomass briquettes comprise at least one of anaerobic digestate, torrefied biomass, and carbonized biomass.

Embodiment 21. The engineered landfill of any of embodiments 18-20 wherein the biomass briquettes have a density of about 0.7-1.4 g/cm³ and a water activity of 0.6 or less.

Embodiment 22. The engineered landfill of any of embodiments 18-21 wherein the water repellent geomembrane has a lower permeability to water than base.

Embodiment 23. The engineered landfill of any of embodiments 18-22 wherein the water repellent membrane comprises at least one membrane selected from the group consisting of polyethylene, polypropylene, polyvinyl chloride, polyethylene terephthalate, acrylonitrile-butadiene-styrene, natural rubber, neoprene rubber, silicone rubber, nitrile rubber, EPDM rubber, styrene-butadiene rubber, butyl rubber, fluorosilicone rubber, paper, wax coated paper, and combinations thereof.

Embodiment 24. The engineered landfill of any of embodiments 18-23 wherein the water repellent membrane comprises recycled materials and/or waste materials.

Embodiment 25. A method comprising: providing a biomass source comprising lignocellulose in an amount greater than 40 wt. %; drying the biomass source such that the biomass source has a water activity of 0.6 or less; compacting the biomass source to have a density of about 0.7-1.4 g/cm³ to produce biomass briquettes; wrapping the biomass briquettes with a water repellent membrane; and placing the biomass briquettes in an engineered landfill.

Embodiment 26. The method of embodiment 25 wherein the biomass source comprises a biomass selected from anaerobic digestate, torrefied biomass, carbonized biomass, and combinations thereof.

Embodiment 27. The method of any of embodiments 25-26 wherein the engineered landfill comprises: a base comprising at least a clay; a plastic geomembrane; and a cap; wherein the water repellent geomembrane is disposed between the base and the cap, and wherein the biomass briquettes are disposed between the base and the cap within the water repellent geomembrane.

Embodiment 28. The method of embodiment 27 wherein the water repellent geomembrane has a lower permeability to water than base.

Embodiment 29. The method of any of embodiments 25-28 wherein the water repellent membrane comprises at least one membrane selected from the group consisting of polyethylene, polypropylene, polyvinyl chloride, polyethylene terephthalate, acrylonitrile-butadiene-styrene, natural rubber, neoprene rubber, silicone rubber, nitrile rubber, EPDM rubber, styrene-butadiene rubber, butyl rubber, fluorosilicone rubber, paper, wax coated paper, and combinations thereof.

Embodiment 30. The method of any of embodiments 25-29 wherein the water repellent membrane comprises recycled materials and/or waste materials.

To facilitate a better understanding of the present invention, the following examples of certain aspects of some embodiments are given. In no way should the following examples be read to limit, or define, the entire scope of the disclosure.

### EXAMPLES

In these examples, the viability of the BIO-CSS process was explored using techno-economic analysis and economic modeling. A base case for Bio-CCS technology was formulated around the hypothesis that under sufficiently dry conditions biogas production will be inhibited and, with slight modifications, this supposition was used in all techno-economic evaluations. A successfully dehydrated Bio-CCS technology deployment would enable sequestration of harvested biomass without intensive chemical conversions such as torrefaction, complete carbonization, anaerobic digestion, or production of second-generation biofuels. From a sequestration standpoint, the carbon efficiency (ε^{carbon}) of successfully sequestered harvested lignocellulosic biomass is approximately 100% carbon efficiency, torrefaction processed biomass is in the range of 80-90%, complete carbonization is approximately 50%, digestate from anaerobic digestion is in a range from 40%-50%, and solid byproducts from second generation biofuels production is likely less than 50%.

To provide perspective on a successful Agro-CCS direct air capture technology, techno-economics and land requirements for harvesting and sequestering two types of energy crops (miscanthus and switchgrass) and one type of tree (loblolly pine) are evaluated in detail. A version of Agro-CCS technology without methodologies that prevent anaerobic degradation is cost effective with a price structure that could drop in the future due to a Moore's law for agriculture A detailed bottoms-up techno-economic analysis is presented supporting this view, albeit with a higher cost structure, because of the inclusion of technology options meant to mitigate or abate anaerobic biodegradation.

For miscanthus and switchgrass the agricultural model includes farmland cost, pre-establishment cost for field preparation, establishment costs, operating expenses (soil tests, seeds or rhizomes, fertilizers), silage type harvesting, and transport to a bio-landfill. Reference (or base case) models were then formulated using a yearly established crop yield of ˜9 metric ton/acre for miscanthus and 5.4 metric ton/acre for switchgrass. For pine the base case cost structure was based on stumpage, forest harvesting, and transportation that results in a cost of green pine (˜45 wt. % water) arriving at the landfill at ˜$38.50/metric ton.

### Example 1

A successful Agro-CCS technology using only dehydration as processing of harvested biomass will be the most economically attractive option because it preserves almost all of the harvested carbon content (ε^{carbon} ˜1). Sequestration is predicated on creating bundles of compressed, dehydrated, and plastic wrapped briquettes with 2-4 wt. % water that are preserved in a dry state in stacks within the bio-landfill. For switchgrass and miscanthus the proposed technology takes harvested crops arriving at the landfill, places them in dry storage under tarps, processes them at a later date into small particulates that undergo heated drying from ˜12 wt. % to ˜2-4 wt. % water, compacts them into 10 in×4 in×4 in 0.9 gram/centimeter³ briquettes, bundles them into stacks of ˜50 briquettes, and plastic wraps the bundles with a 4 mil polyethylene sheet. Modifications of this processing scheme were made for harvested green pine arriving at the landfill so that it could air dry from ˜45 wt. % to ˜20 wt. % water and then be processed and undergo heated drying from 20 wt. % to ˜2-4 wt. % water. Also a somewhat different briquetting technology than that used for the grasses was assumed, producing briquettes with a higher density of 1.2 g/cc. Details of the technology and techno-economic cost structures for these models were fed into discounted cash flow calculations (DCF) that were run with an 8% rate of return, 2% inflation rate, 20% taxation rate, and project life of 18, 14, and 14 years for miscanthus, switchgrass, and pine, respectively. For miscanthus, switchgrass, and pine reference cases, the cost of dehydrated Agro-CCS is respectively $74, $87, and $76/metric ton of CO₂ equivalent. FIG. 3 shows a high level cost breakdown into agricultural and bio-landfilling costs for these reference cases. Also shown in FIG. 3 are brackets that encompass the preponderance of sensitivities that were run around these reference cases. For miscanthus and switchgrass the agricultural sensitivities encompass the range of crop yields, land costs, and farm costs, that might be expected. Pine forestry brackets encompass likely ranges of stumpage charges and harvesting costs. In FIG. 3 it is seen that base case bio-landfill costs, and the ranges bracketing them, are similar for all three biomass sources with switchgrass being the most expensive. Had pine briquettes been prepared with the lower density briquetting technology proposed for switchgrass, the bio-landfill cost for pine and switchgrass would have been very similar. Agricultural costs for the production of pine and miscanthus are very similar. The higher agricultural cost of switchgrass compared to miscanthus is due in large part to the ratio of assumed crop yields with switchgrass/miscanthus= 6/10. For pine the scaling relationship differs because even though it has the lowest yield (˜1.8 dry metric ton/acre/year), it has the lowest land cost as part of the stumpage charge and as such the total base case agricultural cost is similar to miscanthus. In FIG. 3, miscanthus and switchgrass farming costs are broken down into pre-establishment, post crop establishment, and land costs. For pine the total charge of all forestry charges is shown. Landfill costs are broken down into CAPEX and OPEX charges for each crop.

### Example 2

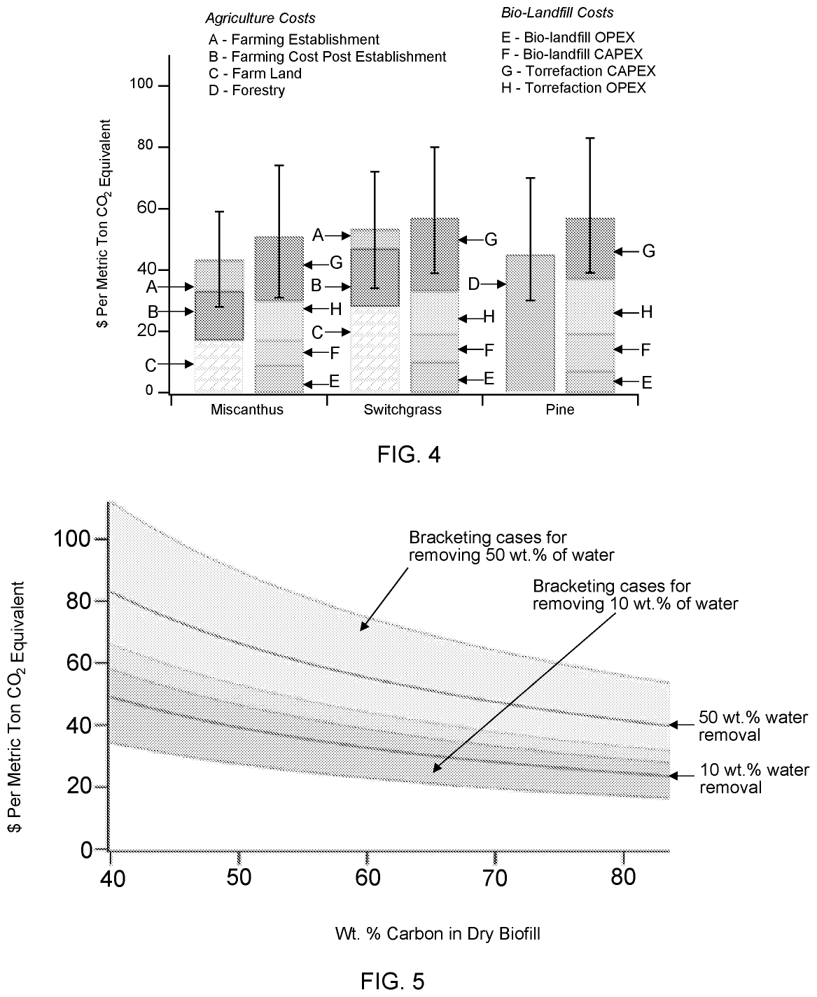

In this example, Agro-CCS of torrefied biomass is explored. Agro-CCS of torrefied biomass is expected to provide a more stable sequestration option with a somewhat higher cost structure because torrefaction introduces a limited amount of carbonization with a small fraction of the harvested carbon content reacting in the anaerobic pyrolysis process to form volatile products (ε^{carbon}˜0.8-0.9). For a base case design a pyrolysis process with a 30 minute long residence time and operating at a temperature of 280 C was selected. Under these conditions more than 80% of the carbon content of the original biomass is retained in the briquette products, and the weight loss of oxygen plus hydrogen is more than 2.5 times greater than the weight loss of carbon. Although large scale torrefaction technology is still in its infancy, many economic models have been developed and this example is templated to analysis of a 150 kTA plant from two of the economic models. By today's standards this is a large plant, however if it became a preferred technological option for torrefied Agro-CCS, a plant producing 3,000 kTA could be envisioned. Energy balance in the torrefaction process is sensitive to the water content of the feedstock as well as the temperature used for torrefaction. For design cases, analysis of a continuous torrefaction process that consumes miscanthus and switchgrass coming from dry storage with 12% water that is expected to produce products (torr gas and condensable hydrocarbons) with more energy than is required to drive the process. Because pine can be continually harvested year-round, the torrefaction process considered consumes green trees arriving at the landfill with ˜45 wt. % water and imports energy to drive the process. A high-pressure briquetting process producing cylindrical briquettes of torrefied product with a density of 1.2 g/cc is incorporated into all designs, increasing landfill utilization. A detailed economic breakdown of capital expenditures (CAPEX) and operational expenditures (OPEX) for agriculture and bio-landfilling along with discounted cash flow (DCF) calculations of sequestration costs was performed. It was found that for miscanthus, switchgrass, and pine reference cases, the cost of torrefied Agro-CCS is respectively $94, $110, and $102/metric ton of CO₂ equivalent. FIG. 4 shows a high level cost breakdown into agricultural and bio-landfilling cost for these reference cases along with brackets encompassing the preponderance of sensitivity studies run around these reference cases. Due to the carbon loss during torrefaction, the agricultural costs shown in FIG. 2 are ˜10-20% higher than those shown in FIG. 3 for dehydrated Agro-CCS with a fairly similar relative ranking of costs between the different biomass sources. Full carbonization of biomass using higher temperature pyrolysis would increase these by almost a factor of two, which in part could be offset by valuation for increased production of ton gas. Even though torrefaction of green pine requires energy import, the total bio-landfill cost is comparable to that for switchgrass because of the higher relative carbon content in the torrefied product. For all crops the carbon content of torrefied products is significantly higher than for the simply dehydrated biomass, providing higher efficiency with lower cost for bio-landfilling of a more degradation-resistant product. In FIG. 4, For miscanthus and switchgrass farming costs are broken down into pre-establishment, post crop establishment, and land costs. For pine the total charge of all forestry charges is shown. Landfill costs are broken down into torrefaction CAPEX, torrefaction OPEX, landfill CAPEX, and landfill OPEX charges for each crop.

### Example 3

In this example the BIO-CSS process is considered with fuel and chemical product production. The chemical conversion of biomass to saleable fuels and products offer residual waste streams that are considered as a second type of biomass input for Bio-CCS. To provide an economic evaluation that covers integration of Bio-CCS with a wide range of potential chemical conversion processes, bio-landfilling and associated processing is treated as a “bolt on” addition to chemical conversion plants utilizing their waste streams as a feed in analysis. As such, valuations that biomass chemical conversion plants such as anaerobic digesters, 2^{nd} generation biofuel refineries, or gas generating pyrolysis plants place on waste byproduct streams would be treated as an additional cost. Cost structures were applied to calculate the Bio-CCS costs of dehydrated waste streams and FIG. 3 shows results for two different amounts of water removal and streams with a range of carbon contents that might be expected as a result of chemical biomass processing. The results of the analysis are shown in FIG. 5. In FIG. 5 BIO-CCS costs for dehydration of waste streams from chemically processed biomass where either 10 wt. % or 50 wt. % water is removed with carbon contents that on a dry basis range from 40 wt. % to 85 wt. %. Costs of the reference (or base cases) in FIG. 5 are found to scale according to the Equation below.

$$Base Case Cost = \frac{{K}_{0} + {K}_{1} {H}_{2} O ( wt . \% )}{Carbon ( wt . \% )}$$

where the Base Case Cost is in $/Metric Ton CO₂ Equivalent, K₀=16.2, K₁=40, H₂O (Wt. %) is the weight percent water removed in the drying process, and Carbon (wt. %) is the weight percent carbon in the dried product. As expected, the base case costs scales as the reciprocal of the weight percent carbon in the dried product, and a portion of the base case cost scales with the amount of water removed. As observed in FIG. 5, dehydrated Bio-CCS will be very economically favorable for high carbon content waste streams with low water content. Without further definition of the molecular content of waste streams from chemical conversion of biomass it is not possible to provide a detailed techno-economic analysis of torrefied Bio-CCS, however a zero order estimate would place costs for torrefaction at $10-$25/metric ton CO₂ Equivalent above the costs for dehydrated Bio-CCS.

Making Bio-CCS and Agro-CCS effective solutions for drawdown of atmospheric carbon dioxide requires preventing, mitigating, or controlling methane release from anaerobic organic matter decomposition. In the examples above, the BIO-CSS solution is shown to be scalable to offset a significant fraction of the world's emissions. The cost structures developed for BIO-CSS show the proposed solutions appear competitive with CO₂ capture and sequestration from point sources and prices would be further expected to drop in the future due to continuing improvements in yields of energy crops and forestry, as well as a learning curve and significant increase in scale of sequestrations. Additional CO₂ capture credits are expected to come from changes in agricultural practices including the integration with regenerative farming practices such as no till, use of perennial grasses, integration or interseeding of cover crops for nitrogen fertilizer reduction or replacement, and livestock integration for both pine and grass cultivation. Regenerative farming methods listed above have been shown to increase soil carbon uptake, as well as avoid or abate emissions from fertilizer use, and credits for this potential change are left to future life cycle assessments of the proposed Bio-CCS and Agro-CCS technologies. Even larger capture credits may ultimately come from use of deeply rooted plants and trees, as more carbon is sequestered underground in these scenarios.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated

1. A method comprising:
providing a biomass source;
processing the biomass source to remove water from the biomass source;
compacting the biomass source to increase density of the biomass source to produce biomass briquettes;
wrapping the biomass briquettes with a water repellent membrane; and
placing the biomass briquettes into a landfill.

2. The method of claim 1, wherein the biomass source comprises at least one biomass source selected from the group consisting of lignocellulosic biomass, anaerobic digestate, torrefied biomass, carbonized biomass, and combinations thereof.

3. The method of claim 1, wherein the biomass briquettes have a density of about 0.7-1.4 g/cm³ and wherein the biomass briquettes have a water activity of 0.6 or less.

4. The method of claim 1, wherein the biomass briquettes comprise water in an amount of less than 4 wt. %.

5. The method of claim 1, wherein the water repellent membrane comprises at least one membrane selected from the group consisting of polymeric membranes, rubber membranes, lignocellulosic membranes, and combinations thereof.

6. The method of claim 1, wherein the water repellent membrane comprises at least one membrane selected from the group consisting of polyethylene, polypropylene, polyvinyl chloride, polyethylene terephthalate, acrylonitrile-butadiene-styrene, natural rubber, neoprene rubber, silicone rubber, nitrile rubber, EPDM rubber, styrene-butadiene rubber, butyl rubber, fluorosilicone rubber, paper, wax coated paper, and combinations thereof and optionally wherein the water repellent membrane comprises recycled materials and/or waste materials.

7. The method of claim 1, wherein the water repellent membrane comprises a membrane thickness of 0.1 mil to 10 mil.

8. The method of claim 1, wherein the comprises a low permeability base and a water repellent geomembrane placed between the biomass briquettes and the low permeability base, wherein the low permeability base comprises at least one base material selected from the group consisting of clay, geosynthetic clay, and combinations thereof, wherein the landfill further comprises a cap and wherein the water repellent geomembrane is further placed between the cap and the biomass briquettes.

9. The method of claim 1, wherein the landfill comprises an engineered landfill comprising channels positioned to drain water away from the biomass briquettes.

10. The method of claim 1, further comprising bundling the biomass briquettes to form briquette bundles and placing the briquette bundles into the landfill.

11. An engineered landfill comprising:
a base comprising at least a clay;
a water repellent geomembrane;
biomass briquettes wrapped with a water repellent membrane; and
a cap;
wherein the water repellent geomembrane is disposed between the base and the cap, and wherein the biomass briquettes are disposed between the base and the cap within the water repellent geomembrane, and wherein the engineered landfill comprises channels positioned to drain water away from the biomass briquettes.

12. The engineered landfill of claim 11, wherein the biomass briquettes comprise lignocellulosic biomass.

13. The engineered landfill of claim 11, wherein the biomass briquettes comprise at least one of anaerobic digestate, torrefied biomass, and carbonized biomass.

14. The engineered landfill claim 11, wherein the biomass briquettes have a density of about 0.7-1.4 g/cm³ and a water activity of 0.6 or less.

15. The engineered landfill claim 11, wherein the water repellent geomembrane has a lower permeability to water than base.

16. The engineered landfill claim 11, wherein the water repellent membrane comprises at least one membrane selected from the group consisting of polyethylene, polypropylene, polyvinyl chloride, polyethylene terephthalate, acrylonitrile-butadiene-styrene, natural rubber, neoprene rubber, silicone rubber, nitrile rubber, EPDM rubber, styrene-butadiene rubber, butyl rubber, fluorosilicone rubber, paper, wax coated paper, and combinations thereof, and optionally wherein the water repellent membrane comprises recycled materials and/or waste materials.

17. A method comprising:
providing a biomass source comprising lignocellulose in an amount greater than 40 wt. %;
drying the biomass source such that the biomass source has a water activity of 0.6 or less;
compacting the biomass source to have a density of about 0.7-1.4 g/cm³ to produce biomass briquettes;
wrapping the biomass briquettes with a water repellent membrane; and
placing the biomass briquettes in an engineered landfill.

18. The method of claim 17, wherein the biomass source comprises a biomass selected from anaerobic digestate, torrefied biomass, carbonized biomass, and combinations thereof.

19. The method of claim 17, wherein the engineered landfill comprises:
a base comprising at least a clay;
a plastic geomembrane; and
a cap;
wherein the water repellent geomembrane is disposed between the base and the cap, and wherein the biomass briquettes are disposed between the base and the cap within the water repellent geomembrane, wherein the water repellent geomembrane has a lower permeability to water than base, wherein the engineered landfill comprises channels positioned to drain water away from the biomass briquettes.

20. The method of claim 17, wherein the water repellent membrane comprises at least one membrane selected from the group consisting of polyethylene, polypropylene, polyvinyl chloride, polyethylene terephthalate, acrylonitrile-butadiene-styrene, natural rubber, neoprene rubber, silicone rubber, nitrile rubber, EPDM rubber, styrene-butadiene rubber, butyl rubber, fluorosilicone rubber, paper, wax coated paper, and combinations thereof, and optionally wherein the water repellent membrane comprises recycled materials and/or waste materials.
